(19) United States
(12) Patent Application Publication
(10) Pub. No.: US 2012/0131154 A1
(43) Pub. Date: May 24, 2012

(54) Synchronous Transport of Business Configuration Data in a Distributed Computing System Environment

(76) Inventors: Wulf Kruempelmann, Altlussheim (DE); Thomas Brodkorb, Wiesloch (DE); Clemens Jacob, Mannheim (DE)

(21) Appl. No.: 12/953,327

(22) Filed: Nov. 23, 2010

(51) Int. Cl. G06F 15/177

(52) U.S. Cl. 709/220

(57) ABSTRACT

Methods, systems, and articles are provided for synchronously exchanging configuration settings in a distributed software system in which interrelated software-implemented business processes execute on both a service provider and a customer landscape. The service provider and the customer landscape each comprise at least one server that in turn include at least one data processor and memory. The service provider includes a test environment and a service provider production environment. The customer landscape includes a quality assurance (QA) environment and a customer landscape production environment. Such an arrangement allows for synchronous transfer of business configuration data in a distributed computing environment.

### TECHNICAL FIELD

The subject matter described herein relates to techniques and systems for transporting business configuration data in distributed computing system environments.

### BACKGROUND

Software applications are increasingly being distributed amongst several computing platforms. For example, applications can share a CRM business process between a service (SAAS) provider and a customer IT center. All systems involved with the business process need to have synchronized business configuration data. However, such coordination can be complex and/or time consuming as the computing platforms are typically associated with and operated by different entities (e.g., companies, etc.). In most cases, individuals associated with each computing platform manually configure each system.

### SUMMARY

Methods, systems, and articles are provided for exchanging configuration settings in a distributed software system in which interrelated software-implemented business processes execute on both a service provider and a customer landscape. The service provider and the customer landscape each comprise at least one server that in turn includes at least one data processor and memory. The service provider includes a test environment and a service provider production environment. The customer landscape includes a quality assurance (QA) environment and a customer landscape production environment. The test environment receives business configuration data from the QA environment that characterizes a business process (e.g., CRM, ERP, etc.) to be implemented between the service provider and the customer landscape. The business configuration data specifies a plurality of business configuration objects utilized by the business process. The service provider test environment stores the specified business configuration objects and releases a transport request. The test environment sends a handle to the QA environment to enable the customer landscape production environment to call the service provider and import required customizing data to the customer landscape which in turn enables the business process. The service provider receives a trigger from the customer landscape and imports the business configuration objects. The service provider production environment sends a commit work message to the customer landscape production environment to enable the business process after the customer landscape production environment has imported the required customizing data.

The service provider and the customer landscape each comprise at least one server that in turn includes at least one data processor and memory. The service provider provides a test environment and a service provider production environment. The customer landscape includes a quality assurance (QA) environment and a customer landscape production environment. The test environment receives business configuration data from the QA environment that characterizes a business process (e.g., CRM, ERP, etc.) to be implemented between the service provider and the customer landscape. The business configuration data specifies a plurality of business objects utilized by the business process. The service provider test environment stores the specified business configuration objects. The service provider test environment also generates and releases a transport request which can transfer the configuration objects to the service provider production environment. The test environment sends a handle on this transport request to the QA environment of the customer IT. When customer IT imports their own business configuration data to the production system of the customer IT this handle is used to trigger the import of the corresponding business configuration objects in the production environment of the service provider. The service provider production environment sends a commit work message to the customer landscape production environment to enable the business process after the customer landscape production environment has imported the required customizing data.

The following describes optional variations which may be implemented singly or in combination. The received business configuration data can be stored in a transport buffer coupled to the test environment. The test environment can perform local modifications based on the received business configuration data and data characterizing the local modifications can be stored in the transport buffer. The test environment can generate a document identifying and providing technical details regarding the business process and this document can be transmitted to the QA environment. The document can be an extensible markup language (XML) document. The document can be transmitted to an application lifecycle management infrastructure (e.g. SAP Solution Manager, etc.) upon activation of the business process to automatically document implementation of the business process. The QA environment can transport the handle to the customer landscape production environment as well as any local changes made to the handle by the QA environment. The service provider can provide services to the customer landscape through at least one web service or at least one Common Object Request Broker Architecture (CORBA).

Articles of manufacture are also described that comprise computer executable instructions permanently (e.g., non-transitorily, etc.) stored on computer readable media, which, when executed by a computer, causes the computer to perform operations herein. Similarly, computer systems are also described that may include a processor and a memory coupled to the processor. The memory may temporarily or permanently store one or more programs that cause the processor to perform one or more of the operations described herein. Methods described herein can be implemented by one or more data processors such that the operations are in turn each implemented by at least one data processor.

The subject matter described herein provides many advantages. For example, the current subject matter allows for the transport of business configuration data in a unified fashion among different computing platforms.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram the transport of business configuration data in a distributed computing system landscape; and

FIG. 2 is a diagram illustrating a distributed computing system including a service provider interacting with a customer landscape.

### DETAILED DESCRIPTION

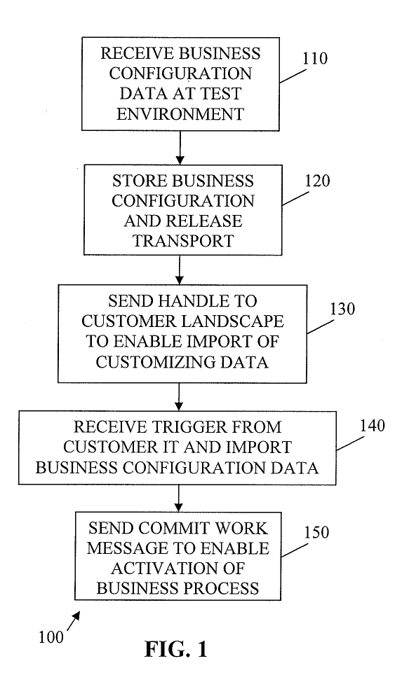

FIG. 1 is a process flow diagram illustrating a method 100 for exchanging configuration settings in a distributed software system in which interrelated software-implemented business processes execute on both a service provider and a customer landscape. The service provider and the customer landscape each comprise at least one server that in turn includes at least one data processor and memory. The service provider includes a test environment and a service provider production environment. The customer landscape includes a quality assurance (QA) environment and a customer landscape production environment. The test environment, at 110, receives business configuration data from the QA environment that characterizes a business process (e.g., CRM, ERP, etc.) to be implemented between the service provider and the customer landscape. The business configuration data specifies a plurality of business configuration objects utilized by the business process. The service provider test environment, at 120, stores the specified business configuration objects and releases a transport request. The test environment, at 130, sends a handle to the QA environment to enable the customer landscape production environment to call the service provider and import required customizing data to the customer landscape which in turn enables the business process. The service provider, at 140, receives a trigger from the customer landscape and imports the business configuration objects. The service provider production environment, at 150, sends a commit work message to the customer landscape production environment to enable the business process after the customer landscape production environment has imported the required customizing data.

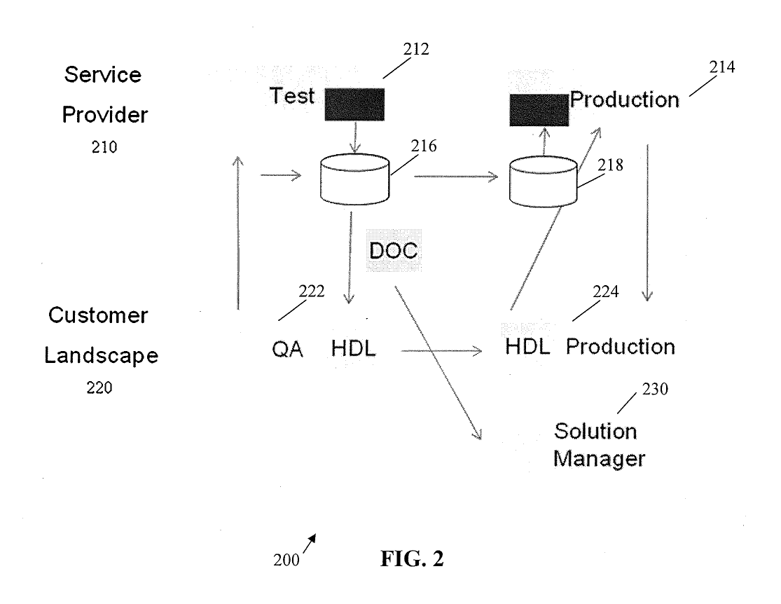

The current subject matter can be used to synchronously transport business configuration data in a multiple system distributed computing landscape. With reference to FIG. 2, a distributed computing system 200 is illustrated that includes a service provider 210 and a customer landscape 220. The service provider 210 and the customer landscape 220 can execute one or more related business processes which require business configuration data. Such business configuration data needs to be coordinated/conveyed between the service provider 210 and the customer landscape 220 in order to properly function.

Each of the service provider 210 and the customer landscape 220 can include one or more servers (each having at least one data processor and memory) which are connected via a computer network (e.g., the Internet, an intranet, etc.). The service provider 210 can include both a test environment 212 and a production environment 214. Similarly, the customer landscape 220 can include a quality assurance (QA) environment 222 and a production environment 224. While the environments 212, 214, 222, 224 are illustrated as separate systems, it will be appreciated that they can form part of a single computing system with proper bifurcation/segregation. The test environment 212 is used by the service provider 210 to stage an initial rollout of a business process or modifications to a business process prior to being made available on the production environment 214.

At the customer landscape 220, the QA environment 222 interacts with the test environment 212 to ensure that the pre-production business process is functioning properly. Once the business process is released in the production environment 214 of the service provider 210, the production environment 224 of the customer landscape 220 can utilize such business process. In addition, the test environment 212 of the service provider 210 can include a transport buffer 216 to persist testing and/or customizing related data.

The QA environment 222 can transfer business configuration data to the test environment 212. The transfer can initiate and/or customize a business process and can additionally include relevant transport business configuration data relating to the customization of data relevant for the business processes. This business configuration data can specify business objects (whether new, previously generated, or extensions of existing business objects) that are to be utilized by the business. The test environment 212 subsequently ensures that all objects references in the business configuration data are released and persistent in the productive environment 214. In addition, any relevant customizing data associated with the business configuration data (which can include some or all of the business configuration data and/or local customizing by the service provider 210) can be stored in the transport buffer 216.

After the test environment 212 completes the customizing specified in the business configuration data, the transport request is released so that the production environment 214 relevant configuration settings based on the business configuration data can be developed/tested in such environment. In addition, a document describing the business process (e.g., an XML document providing technical specifications for the business process, etc.) can be generated (and stored in the transport buffer 216 to enable future revisions) and sent to the QA environment 222 of the customer landscape 220. The document can include a handle to reference blocks of memory or objects managed by the service provider 210 in connection with the business processes (such objects can be stored, for example, in a secondary persistence 218). Alternatively, the handle can be sent separately to the QA environment 222. The handle is used by the QA environment to interact with the production environment 214 of the service provider 210. Once it is established by the QA environment 222 (which can be an automated and/or manual testing processing) that the production environment 214 of the service provider 210 accurately implements the business process, the QA environment 222 can transport the handle (along with any local changes that may have been implemented during QA testing of the production environment 214 of the service provider) to the production environment 224 of the customer landscape 220. The handle in the production environment 224 of the customer landscape 220 can then call production environment 214 of the service provider 210 to initiate the import of customizing data from the customer landscape 220. Once the production environment 214 of the service provider 210 finalizes this import, it can send a commit work message to the production environment 224 of the customer landscape 220 to enable the business process. This commit work message can be stored with the XML document in the transport buffer 216. If the activation of the business process is not successful, then a transport error log can be sent to the customer landscape 220 and the entire business process can be locked.

In some implementations, the activation of the business process results in the XML document being sent to an application lifecycle management infrastructure (e.g. SAP Solution Manager, etc.) 230 for automated documentation of the solution. The solution manager 230 is a tool that can be used to enable service and support for the customer landscape 220 (it can also act to identify and record business processes, especially for business processes used in highly regulated industries such as finance, environmental, and healthcare).

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

What is claimed is:

1. A method for exchanging configuration settings in a distributed software system in which interrelated software-implemented business processes execute on both a service provider and a customer landscape, the service provider and the customer landscape each comprising at least one server, each server including at least one data processor and memory, the service provider including a test environment and a service provider production environment, the customer landscape including a quality assurance (QA) environment and a customer landscape production environment, the method comprising:
receiving, by the test environment from the QA environment, business configuration data characterizing a business process to be implemented between the service provider and the customer landscape, the business configuration data specifying a plurality of business objects utilized by the business process;
storing, by the test environment, the specified business objects;
releasing, by the test environment, a transport request,
sending, by the test environment to the QA environment, a handle to enable the customer landscape production environment to call the service provider and import required customizing data to the customer landscape to enable the business process;
receiving, by the service provider, a trigger from the customer landscape to result in importing of business objects; and
sending, by the service provider production environment to the customer landscape production environment, a commit work message to enable the business process after the customer landscape production environment has imported the required customizing data.

2. A method as in claim 1, wherein the received business configuration data is stored in a transport buffer coupled to the test environment.

3. A method as in claim 2, further comprising:
performing, by the test environment, local modifications based on the received business configuration data; and
storing, by the test environment, data characterizing the local modifications in the transport buffer.

4. A method as in claim 1, further comprising:
generating, by the test environment, a document identifying and providing technical details regarding the business process; and
transmitting, by the test environment, the document to the QA environment.

5. A method as in claim 4, wherein the document is an extensible markup language (XML) document.

6. A method as in claim 4, further comprising:
transmitting the document to an application lifecycle management infrastructure upon activation of the business process to automatically document implementation of the business process.

7. A method as in claim 1, further comprising:
transporting, by the QA environment to the customer landscape production environment, the handle as well as any local changes made to the handle by the QA environment.

8. A method as in claim 1, further comprising:
transmitting, by the QA environment to the test environment, the business configuration data.

9. A method as in claim 1, wherein the service provider provides services to the customer landscape through at least one web service or at least one Common Object Request Broker Architecture (CORBA).

10. An article of manufacture for exchanging configuration settings in a distributed software system in which interrelated software-implemented business processes execute on both a service provider and a customer landscape, the service provider and the customer landscape each comprising at least one server, each server including at least one data processor and memory, the service provider including a test environment and a service provider production environment, the customer landscape including a quality assurance (QA) environment and a customer landscape production environment, the article comprising:
computer executable instructions non-transitorily stored on computer readable media, which, when executed by a computer, causes the computer to perform operations comprising:
receiving, by the test environment from the QA environment, business configuration data characterizing a business process to be implemented between the service provider and the customer landscape, the business configuration data specifying a plurality of business objects utilized by the business process;
storing, by the service provider test environment, the specified business objects;
sending, by the test environment to the QA environment, a handle to enable the customer landscape production environment to call the service provider and import required customizing data to the customer landscape to enable the business process; and
sending, by the service provider production environment to the customer landscape production environment, a commit work message to enable the business process after the customer landscape production environment has imported the required customizing data.

11. An article as in claim 10, wherein the received business configuration data is stored in a transport buffer coupled to the test environment.

12. An article as in claim 11, wherein the operations further comprise:
performing, by the test environment, local modifications based on the received business configuration data; and
storing, by the test environment, data characterizing the local modifications in the transport buffer.

13. An article as in claim 10, wherein the operations further comprise:
generating, by the test environment, a document identifying and providing technical details regarding the business process; and
transmitting, by the test environment, the document to the QA environment.

14. An article as in claim 13, wherein the document is an extensible markup language (XML) document.

15. An article as in claim 13, wherein the operations further comprise:
transmitting the document to an application lifecycle management infrastructure upon activation of the business process to automatically document implementation of the business process.

16. An article as in claim 10, wherein the operations further comprise:
transporting, by the QA environment to the customer landscape production environment, the handle as well as any local changes made to the handle by the QA environment.

17. An article as in claim 10, wherein the operations further comprise:
transmitting, by the QA environment to the test environment, the business configuration data.

18. An article as in claim 1, wherein the service provider provides services to the customer landscape through at least one web service or at least one Common Object Request Broker Architecture (CORBA).

19. A system comprising:
a service provider providing one or more networked software solutions, the service provider comprising one or more servers, each server including at least one data processor and memory, the service provider including a test environment and a service provider production environment;
a customer landscape remote from the service provider consuming the one or more networked software solutions of the service provider, the customer landscape comprising one or more servers, each server including at least one data processor and memory, the customer landscape including a quality assurance (QA) environment and a customer landscape production environment;
wherein:
the test environment receives business configuration data from the QA environment characterizing a business process to be implemented between the service provider and the customer landscape, the business configuration data specifying a plurality of business objects utilized by the business process;
the service provider production environment persists the specified business objects;
the test environment sends a handle to the QA environment to enable the customer landscape production environment to call the service provider and import required customizing data to the customer landscape to enable the business process; and
the service provider production environment sends a commit work message to the customer landscape production environment to enable the business process after the customer landscape production environment has imported the required customizing data.

20. A system as in claim 19, further comprising: a transport buffer associated with the test environment for storing configuration settings associated with the business process.
